(19) United States
(12) Patent Application Publication
(10) Pub. No.: US 2009/0040619 A1
(43) Pub. Date: Feb. 12, 2009

(54) OPTICAL FILTER FOR DISPLAY APPARATUS

(75) Inventors: Jae Young CHOI, Seoul (KR); Gi-Mo Yang, Gumi Si (KR); Dae Chul Park, Suwon-si (KR)

Correspondence Address: MCDERMOTT WILL & EMERY LLP, 600 13TH STREET, N.W., WASHINGTON, DC, 20005-3096, US

(73) Assignee: SAMSUNG CORNING PRECISION GLASS CO., LTD.

(21) Appl. No.: 12/186,194

(22) Filed: Aug. 5, 2008

(30) Foreign Application Priority Data
Aug. 6, 2007 (KR) 10-2007-0078776

(51) Int. Cl. G02B 5/22

(52) U.S. Cl. 359/614

(57) ABSTRACT

The present invention provides an optical filter for display apparatus. The optical filter includes a glass substrate, and an external light shield including an external light shielding pattern comprising a plurality of external light shielding parts including a light-absorbing substance, wherein the external light shield is formed by coating one side of the glass substrate with a transparent resin and the plurality of external light shielding parts are formed on the exposed surface of the transparent resin.

### CROSS-REFERENCE TO RELATED APPLICATION

This application claims the benefit of Korean Patent Application No. 10-2007-78776, filed on Aug. 6, 2007, in the Korean Intellectual Property Office, the entire disclosure of which is incorporated herein by reference.

### BACKGROUND OF THE INVENTION

1. Field of the Invention

The present invention relates to an optical filter for display apparatus, and in particular the optical filter may improve a contrast ratio and visibility in a room with sunlight and also reduce manufacturing costs by using a simple manufacturing process.

2. Description of Related Art

As modern society becomes more information oriented, technology of parts and devices related to image displays is remarkably advancing, and these parts and devices are becoming widespread. Display apparatuses for displaying images are becoming significantly widespread and used for television apparatuses, monitor apparatuses of personal computers, and the like. Also, display apparatuses are becoming both larger and thinner.

Plasma display panel (PDP) apparatuses are generally gaining popularity as next-generation display apparatuses to simultaneously satisfy a trend of becoming larger, and of becoming thinner, when compared with cathode-ray tubes (CRTs) representing existing display apparatuses.

The PDP apparatuses display images using a gas discharge phenomenon, and exhibit superior display characteristics such as display resolution, brightness, contrast ratio, an afterimage, a viewing angle, and the like. Also, since the PDP apparatuses are generally seen as having the most appropriate characteristics for future high-quality digital televisions due to thin luminous display apparatuses of which enlargement is simpler than any other display apparatus, the PDP apparatuses are gaining popularity as display apparatuses and are replacing CRTs.

The PDP apparatus generates a gas discharge between electrodes by a direct current (DC) voltage or an alternating current (AC) voltage which are supplied to the electrodes. Here, ultraviolet light is generated. Then, a phosphor is excited by ultraviolet light, thereby emitting light.

However, the PDP apparatus has a defect in that an amount of emitted electromagnetic (EM) radiation and near infrared (NI) radiation with respect to a driving characteristic is great, surface reflectivity of the phosphor is great, and color purity due to orange light emitted from neon (Ne), or xenon (Xe) used as a sealing gas is lower than the CRT.

Therefore, EM radiation and NI radiation generated in the PDP apparatus may have harmful effects on human bodies, and cause sensitive equipments such as wireless telephones, remote controls, and the like, to malfunction. In order to use the PDP apparatus, it is required to prevent emission of EM radiation and NI radiation emitted from the PDP apparatus from increasing to more than a predetermined level. PDP filters having functions such as an EM radiation-shielding function, an NI radiation-shielding function, a surface antiglare function, enhancement of color purity, and the like, are used for EM radiation-shielding and NI radiation-shielding while simultaneously reducing reflected light, and enhancing color purity.

The PDP filter is manufactured by laminating a plurality of functional shields such as an EM radiation-shield, an NI radiation shield, a Ne light-shield, and the like, with an adhesive or a gluing agent. Additionally, the PDP filter may have an external light shielding layer, which is used to enhance contrast ratio and brightness by shielding external light and absorbing external light reflected by panel.

A conventional external light shield is manufactured through a laminating process by adhesion of a film with black stripes in parallel on a display screen in horizontal direction. A conventional film has defects in that a protective film, a release film and pressure sensitive adhesive (PSA) are essentially required; images can be overlapped with each other (ghost phenomenon); and a perpendicular viewing angle is limited.

### SUMMARY OF THE INVENTION

An aspect of the present invention, in consideration of above-mentioned defects, is to provide an optical filter which effectively shields external light in a display apparatus. The optical filter is manufactured by resin-coating directly on a glass substrate without a using laminating process, so a protective film, a release film, and a PSA are not required.

Another aspect of the present invention is to provide an optical filter for a display apparatus by using an external light shielding pattern comprising cone-shaped shielding parts, thereby obtaining a broad viewing angle from any direction.

Another aspect of the present invention is to provide an optical filter for display apparatus by which initial costs of the optical filter can be reduced by blending resin of the optical filter with a colorant for color compensation and colorants for performing NI radiation shielding and Ne-cutting. Therefore, there is no need for separately manufacturing a film for color compensation.

According to an aspect of the present invention, there is provided an optical filter for a display apparatus including a glass substrate and an external light shield including an external light shielding pattern comprising a plurality of external light shielding parts including a light-absorbing substance, wherein the external light shield is formed by coating one side of the glass substrate with a transparent resin and the plurality of external light shielding parts are formed on the exposed surface of the transparent resin.

According to another aspect of the present invention, the external light shielding pattern of the optical filter includes either a plurality of stripe-shaped external light shielding parts cross-section of which is in a wedge shape, or a plurality of cone-shaped external light shielding parts. The cross section of the stripe-shaped external light shielding part is not limited to a wedge shape, and is able to be in a trapezoid shape, U-shape, a half circle shape, and the like.

According to another aspect of the present invention, the refractive index of the external light shielding parts is lower than the refractive index of the transparent resin. The refractive index of the external light shielding parts may be lower than the refractive index of the transparent resin by a range of 0.01 to 0.5.

According to another aspect of the present invention, the transparent resin includes at least one colorant which selectively absorbs light. The kind of colorant includes a colorant for color compensation according to an absorption wavelength, a colorant for Ne-cutting, and the like. The colorant includes at least one of colorants including cyanine-based compound, anthraquinone-based compound, phthalocyanine-based compound, naphthalocyanine-based compound, diimmonium-based compound, nickeldithiol-based compound, azo-based compound, styryl-based compound, phthalocyanine-based compound, and methyl-based compound.

According to another aspect of the present invention, the plurality of the cone-shaped external light shielding parts being adjacent to one of the cone-shaped external light shielding parts make either a square shape or a diamond shape together when viewed from the top of the external light shield.

According to another aspect of the present invention, the light-absorbing substance of the optical filter includes carbon black. Black liquid, gas, or solid can be used as the light-absorbing substance.

The optical filter for display apparatus disclosed in the present invention can be variously applied to a PDP apparatus, an Organic Light Emitting Diode (OLED), Liquid Crystal Display (LCD), or Field Emission display utilizing cross stripes-pattern pixel and realizing RGB. When the optical filter of the present invention is utilized as a part of a PDP filter included in a PDP apparatus, the optical filter adheres to the front of a panel of the PDP, and may further include various functional films such as a EM radiation shielding film, a color compensation film, an NI shielding film, an anti-reflection film, and the like.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a perspective view of an optical filter according to an embodiment of the present invention;

FIG. 2 is a perspective view of an optical filter according to another embodiment of the present invention;

FIG. 3 is a top view of the optical filter of FIG. 2; and

FIG. 4 is a top view of an optical filter according to yet another embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

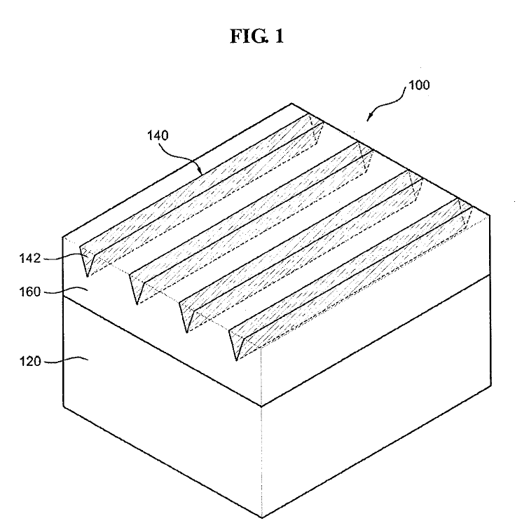

FIG. 1 is a perspective view illustrating an optical filter 100 for a display apparatus according to an exemplary embodiment of the present invention.

Referring to FIG. 1, the optical filter 100 for a display apparatus according to the exemplary embodiment of the present invention includes a transparent resin 160 on which a glass substrate 120 and an external light shielding pattern 140 is formed. The external light shielding pattern 140 includes a plurality of stripe-shaped external light shielding parts 142, and a cross section of the stripe-shaped external light shielding parts is in a wedge shape.

The optical filter 100 is manufactured by coating the transparent resin 160 on one side of the glass substrate 120, forming a stripe-shaped intagliated pattern which has a predetermined cross sectional shape (not illustrated) on an exposed surface of the transparent resin 160, and filling up the intagliated pattern with a light-absorbing substance and subsequently curing the light-absorbing substance. The cross section of the intagliated pattern can be in a variety of shapes such as a trapezoid shape, a U-shape, a half-circle shape, and the like.

A conventional method for forming a pattern includes a hot pressure process that a heated mold is pressed onto a thermoplastic resin, a casting process where a thermoplastic resin composition is injected in a mold and solidified, an injection molding process, and a UV process where UV-curable resin composition is injected into a mold and cured. The shape of the pattern is variously formed according to a mold, and the pattern is generally in a wedge shape. After forming a pattern, a resin including coloring particles such as carbon black, and the like, is injected to a transparent resin which has the pattern formed thereon by using a wiping process, and then cured.

When using a conventional optical filter, it is required to manufacture either a separate film or a sheet with polymer resin material and the film or the sheet adheres to a glass through a laminating process, whereas the present invention improves efficiency of manufacturing process by coating the transparent resin directly on a glass substrate. Therefore, the present invention does not need a protective film, a release film, and a PSA which are required from the conventional optical filter.

The external light shielding part 142 mainly absorbs external ambient light, thereby increasing a contrast ratio of a display and may further include a conductive material depending on purpose.

A desirable method of forming the external light shielding part 142 is injecting a material having a lower refractive index than that of the transparent resin 160. Since the transparent resin is a general UV-curable resin, the refractive index is about 1.56, it is desirable that the refractive index of the external light shielding parts is lower than that of the transparent resin by a range of 0.01 to 0.5. When a refractive index of the external light shielding part 142 is lower than that of the glass substrate 120, the absorption of incident light from display panel is minimized, so that light emission by total reflecting the incident light can be maximized. Also, transmitted external light into the optical filter 100 is absorbed by the light-absorbing substance and shielded, thereby raising a contrast ratio of a display.

The external light shielding part 142 may be filled with a black gas, liquid, or solid, and carbon black is generally used. The external light shielding part 142 may be filled with a resin compound including a polymer resin, binder, and the like, together with a black substance. In this case, it is desirable that the refractive index of the component of the resin included in the external light shielding part 142 is lower than that of the transparent resin 160, which is external to the external light shielding part 142.

The transparent resin 160 may include at least one of colorants which selectively absorb light. The colorant is capable of performing color compensation, NI radiation shielding, Ne-cutting, and the like. In particular, at least one of colorants including cyanine-based compound, anthraquinone-based compound, phthalocyanine-based compound, naphthalocyanine-based compound, dimonium-based compound, nickeldithiol-based compound, azo-based compound, styryl-based compound, phthalocyanine-based compound, and methyl-based compound may be used as the colorant.

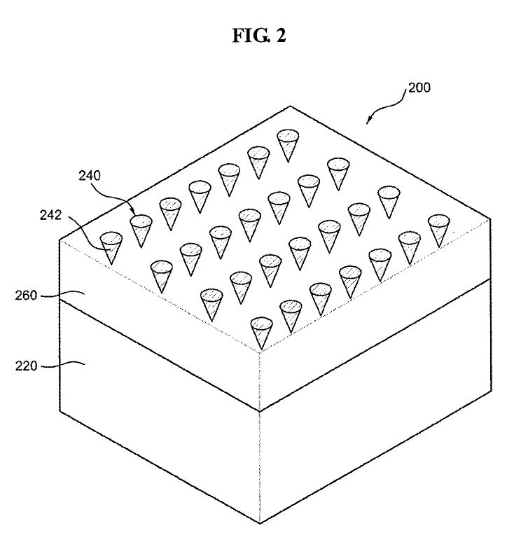

FIG. 2 is a perspective view illustrating an optical filter 200 for a display apparatus according to another exemplary embodiment of the present invention. Herein, descriptions repeating the descriptions of the optical filler illustrated in FIG. 1 are omitted.

Referring to FIG. 2, the optical filter 200 for a display apparatus according to the exemplary embodiment of the present invention includes a glass substrate 220 and transparent resin 260 on which external light shielding pattern 240 is formed. The external light shielding pattern 240 includes a plurality of external light shielding parts 242 which are in a cone shape. The optical filter 200 is manufactured by coating a transparent resin 260 on one side of the glass substrate 220, forming a regularly repeated cone-shaped intagliated pattern (not illustrated) on an exposed surface of the transparent resin 260, and filling up the intagliated pattern with a light-absorbing substance and subsequently curing the light-absorbing substance.

The cone-shaped external light shielding part 242 may enable total reflection and absorption regardless of the direction of the incident light, thereby having a broader vertical viewing angle than that of a stripe-shaped external shielding part 142.

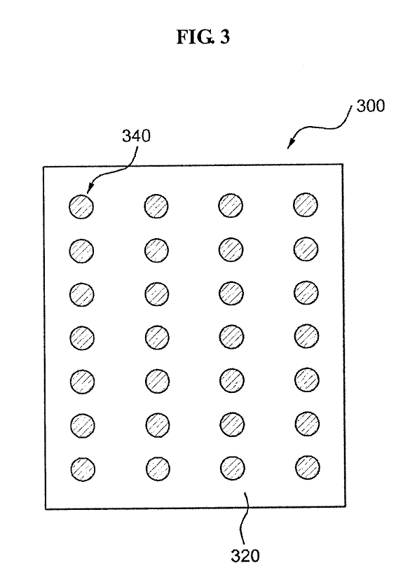

FIG. 3 is a top view of the optical filter 200 of FIG. 2.

Referring to FIG. 3, an optical filter 300 for a display apparatus according to another exemplary embodiment of the present invention includes external light shielding parts 340 and a transparent resin 320. A plurality of the external light shielding parts 340 included in the transparent resin 320 are separated from each other at regular intervals and are regularly arranged in 2-dimensions. Four cone-shaped external light shielding parts 340 being adjacent to one another are in a square shape when viewed from the top.

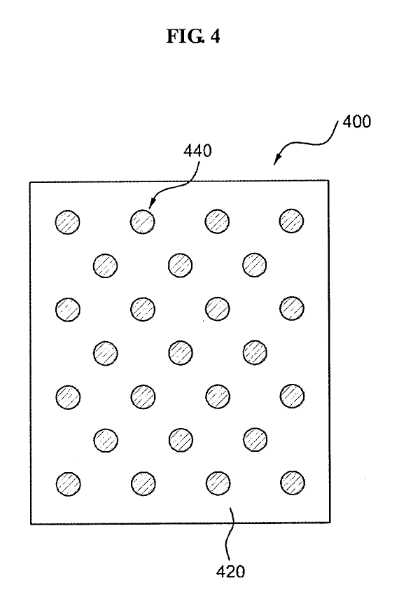

FIG. 4 is a top view of an optical filter according to yet another embodiment of the present invention. Referring to the FIG. 4, an optical filter 440 includes external light shielding parts 440 and a transparent resin 420. A plurality of the external light shielding parts 440 included in the transparent resin 420 are separated from each other at regular intervals and are regularly arranged in 2-dimensions. Four cone-shaped external light shielding parts 440 being adjacent to one another are in a diamond shape when viewed from the top.

The present invention is not limited in the above described embodiments and the external light shielding parts 340 and 440 may be arranged in other shapes besides a square or a diamond.

The optical filter for a display apparatus according to the present invention is manufactured by resin-coating directly on a glass substrate without using a laminating process, so a protective film, a release film, and a PSA are not required, thereby simplifying a manufacturing process and reducing manufacturing costs.

Also, an optical filter for a display apparatus according to the present invention uses an external light shielding pattern comprising cone-shaped shielding parts, thereby obtaining a broad viewing angle from any direction.

Also, an optical filter for a display apparatus according to the present invention can perform color compensation, NI radiation shielding, and Ne-cutting in combination so that it is economical and efficient.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An optical filter for display apparatus, comprising:
a glass substrate; and
an external light shield including an external light shielding pattern comprising a plurality of external light shielding parts including a light-absorbing substance,
wherein the external light shield is formed by coating one side of the glass substrate with a transparent resin and the plurality of external light shielding parts are formed on the exposed surface of the transparent resin.

2. The optical filter of claim 1, wherein the external light shielding pattern includes either a plurality of stripe-shaped external light shielding parts having a cross-section in a wedge shape, or a plurality of cone-shaped external light shielding parts.

3. The optical filter of claim 1, wherein the refractive index of the external light shielding parts is lower than the refractive index of the transparent resin.

4. The optical filter of claim 1, wherein the transparent resin includes at least one colorant which selectively absorbs light.

5. The optical filter of claim 2, wherein the cone-shaped external light shielding parts being adjacent to one of the cone-shaped external light shielding parts are in either a square shape or a diamond shape when viewed from the top of the external light shield.
